(19) United States
(12) Patent Application Publication
(10) Pub. No.: US 2015/0350072 A1
(43) Pub. Date: Dec. 3, 2015

(54) Apparatus and Method for Transmitting Data

(71) Applicant: SIEMENS AKTIENGESELLSCHAFT, München (DE)

(72) Inventors: Rainer FALK, Poing (DE); Steffen FRIES, Baldham (DE)

(21) Appl. No.: 14/433,666

(22) PCT Filed: Aug. 8, 2013
(86) PCT No.: PCT/EP2013/066658

§ 371 Date: Apr. 4, 2015

(30) Foreign Application Priority Data
Oct. 4, 2012 (DE) 10 2012 218 111.3

(51) Int. Cl. H04L 12/741; H04L 29/06

(52) U.S. Cl. CPC H04L 45/74; H04L 63/062

(57) ABSTRACT

An apparatus (10) for transmitting data (D(1)) is proposed. The apparatus (10) comprises a physical structure (11) for providing a physical fingerprint (F), a generation unit (12) for generating an identifier (ID) for the apparatus on the basis of the provided physical fingerprint (F) and a transmission unit (13) for transmitting data (D(1)) with a piece of sender-specific information produced on the basis of the generated identifier (ID) to a receiver. Hence, data transmission with a secure and inexpensive identifier for identifying the sending apparatus to the receiver is provided. hi addition, a method and a computer program product for transmitting data are proposed.

The present invention relates to an apparatus and a method for transmitting data.

Apparatuses or devices for transmitting data, for example control devices or field devices, have an identifier or device identity, for example a serial number or a MAC address of a network interface. The device can be identified by the receiver, in particular, using this identifier. A device can use cryptographic authentication methods to prove that it is entitled to use a particular identifier.

For example, a device may have a plain text identifier, for example a MAC address or a network interface identifier. However, a device may be authenticated during cryptographic authentication using an apparatus-specific certificate, for example according to X.509, as part of cryptographic authentication, for example using Internet Key Exchange (IKE) or Secure Sockets Layer (SSL). However, a cryptographically protected device identity in practice disadvantageously results in a considerable amount of additional effort. In contrast, a simple device identity can be copied using very simple means.

Furthermore, different variants of how a device can determine its IP address itself are known in the data transmission protocol IPv6. In this case, the IPv6 address consists of a prefix and an identifier selected by the device. The identifier can be formed in different ways.

In a first variant, the identifier can be formed on the basis of a MAC address or a network interface (interface identifier). In a second variant, the identifier is formed in a pseudo-random manner using a random number generator (Internet standard RFC4941). In a third variant, use is made of a key derivation from a public key of the device (CGA, Cryptographically Generated Addresses, Internet standard RFC3972).

Furthermore, PUF authentication is known (PUF, Physical Unclonable Function). Different implementations are also known in this case. For example, a device is conventionally authenticated using a PUF. For this purpose, the verifier provides the device to be authenticated with query values.

Device fingerprinting is also known, in which a radio transmitter is identified using the transient response of the transmission stage (see, for example, Brik, Banerjee, Gruteser, Oh: Wireless Device Identification with Radiometric Signatures, Mobicom '08 Proceedings of the 14th ACM International conference on Mobile computing and networking, pages 116-127, ACM, 2008; http://pages.cs.wisc.edu/˜suman/pubs/paradis.pdf; Danev Capkun: Transient-based Identification of Wireless Sensor Nodes, IPSN '09 Proceedings of the 2009 International Conference on Information Processing in Sensor Networks, pages 25-36, IEEE, 2009 http://www.syssec.ethz.ch/research/TIWSN_ISPN09.pdf.). In this case, a wireless transmission node is identified without its contribution using effects which are typical of it and are repeated in a plurality of transmissions. They can therefore be copied or simulated like a device identifier.

Overall, an object of the present invention is to provide data transmission from an apparatus having a secure and cost-effective identifier for identifying the transmitting apparatus.

Accordingly, an apparatus for transmitting data is proposed. The apparatus comprises a physical structure for providing a physical fingerprint, a generation unit for generating an identifier of the apparatus on the basis of the physical fingerprint provided, and a transmission unit for transmitting data, with an item of sender-specific information produced on the basis of the generated identifier, to a receiver.

The invention provides data transmission with a secure and cost-effective identifier for identifying the transmitting apparatus with respect to the receiver. In contrast to conventional device fingerprinting, a physical fingerprint is provided here in order to intentionally transmit an item of sender-specific information. The sender-specific information can also be referred to as device-specific additional information.

The present apparatus can be implemented using very simple circuitry means. There is no need to implement cryptographic algorithms and there is no need to produce, distribute, store and manage any cryptographic keys. In contrast to the known transmitter fingerprinting, a considerably reduced amount of effort is needed in the receiver to acquire the information since the latter can be explicitly transmitted. In contrast to a fixed plain text identifier, spoofing in which an attacker simply transmits data using the identity of another apparatus is made more difficult.

In contrast to a randomly selected address, a receiver can determine and check the sender. In contrast to a transmission address derived from a cryptographic key, there is no need for a cryptographic key and any cryptographic calculations. The amount of effort required, in particular the computing effort and therefore the cost, is therefore considerably lower.

The apparatus may be a device or a node for transmitting data, a control device, a field device or the like.

The physical structure of the apparatus is suitable for providing the physical fingerprint. The physical fingerprint may be a PUF (Physical Unclonable Function). A PUF is a function which is formed in a physical structure of the apparatus and can be easily evaluated but is difficult to predict. Furthermore, a device-specific PUF is simple to produce but is virtually impossible to duplicate even if exactly the same production process is reproduced. In this respect, the PUF can be referred to as a hardware analog to the one-way function.

The identifier may also be referred to as an identification or a device identity. The device-specific identifier is generated by means of the device-specific PUF or the device-specific physical fingerprint. The sender-specific information is generated directly or indirectly from this device-specific identifier. If generated directly, the sender-specific information can also correspond to the identifier. If generated indirectly, the identifier is an input parameter for producing the sender-specific information. The sender-specific information can be coded directly or indirectly into the data to be transmitted. For example, the sender-specific information may form the transmission address for the data. Alternatively, the sender-specific information can also be in the form of a determining parameter for the coding used or the modulation used to transmit the data.

For example, the device-specific identifier can determine a parameter of the modulation method used, for example the spreading code to be used. An oscillator can also be modulated from the identifier in order to modulate the transmission frequency.

The receiver checks the device-specific identifier. If there is sufficient similarity, a plurality of messages are assigned to the same sender. The aim could be sender authentication or else only a similarity check during which a receiver can assign a plurality of separately received messages from a sender to one another with a high degree of reliability. This prevents or at least makes it difficult for an attacker to be able to manipulate this communication by loading manipulated data.

In one embodiment, the transmission unit is set up to transmit the data to the receiver in the form of data packets containing useful data and header data and to form a transmission address for the header data as the sender-specific information using the generated identifier.

In this embodiment, the sender-specific information and therefore the identifier of the apparatus are directly and immediately coded into the data packet to be transmitted. Therefore, the receiver can easily extract the device-specific identifier from the received data packet in order to reliably determine and check the sender.

In another embodiment, the transmission unit is set up to use the generated identifier as the transmission address.

It is simple to already use the generated identifier as the transmission address. This solution is therefore also very cost-effective.

In another embodiment, the transmission unit is set up to produce an identifier signal as the sender-specific information using the generated identifier and to modulate the produced identifier signal onto a useful data signal for transmitting the data to the receiver. The produced identifier signal is a noise signal, for example.

As a result, the sender-specific information can be easily and securely transmitted when transmitting the data. The receiver can then recover the identifier signal using demodulation and can calculate the identifier from the recovered identifier signal.

In another embodiment, the transmission unit is set up to transmit the sender-specific information to the receiver by modulating a predetermined side channel during transmission of the data, which modulation is determined on the basis of the generated identifier.

Modulating a particular side channel comprises, for example, modulating the power consumption profile of the apparatus or a heating profile of the apparatus.

The sender-specific information can therefore be transmitted securely and separately from the useful data.

In another embodiment, the transmission unit comprises a modulator for modulating the data and a transmitter for transmitting the modulated data to the receiver via a predetermined transmission medium.

In another embodiment, the modulator is set up to initialize the modulation of the data using the generated identifier and to modulate the data using the initialized modulation in order to transmit the sender-specific information.

On the one hand, this embodiment is simple to implement and, on the other hand, the sender-specific information is transmitted securely and in a concealed manner.

In another embodiment, the transmission unit comprises a frequency spreading unit, a modulator and a transmitter. In this case, the frequency spreading unit is set up to initialize a frequency spreading sequence using the generated identifier. The modulator is set up to modulate the data using the initialized frequency spreading sequence in order to transmit the sender-specific information. Furthermore, the transmitter is set up to transmit the modulated data to the receiver via a predetermined transmission medium.

This embodiment is simple to implement. In addition, the sender-specific information is transmitted securely and in a concealed manner.

In another embodiment, the apparatus comprises a key generation unit for generating a cryptographic key. The key generation unit is initialized by the physical fingerprint and/or by a further physical fingerprint of the apparatus. In addition, the apparatus comprises a production unit for producing cryptographic data using the generated cryptographic key. In this case, the transmission unit is set up to transmit the produced cryptographic data, with an item of sender-specific information produced on the basis of the generated identifier, to the receiver via a predetermined transmission medium.

There are three variants for initializing the key generation unit in this case.

In a first variant, the key generation unit is initialized by the physical fingerprint.

In a second variant, the key generation unit is initialized by the further physical fingerprint.

In a third variant, both the physical fingerprint and the further physical fingerprint are used to initialize the key generation unit. These variants are particularly secure, in particular with respect to transmitting the sender-specific information.

In the case of changing identifiers which are produced by means of different physical fingerprints, in particular, it is difficult to track an apparatus, for example a node. User tracking is therefore also prevented, for example.

In another embodiment, the apparatus comprises a further physical structure for providing the further physical fingerprint.

In another embodiment, the cryptographic data comprise a cryptographic checksum calculated using the produced cryptographic key.

In another embodiment, the cryptographic data comprise encrypted useful data encrypted using the produced cryptographic key.

In another embodiment, the key generation unit comprises a fuzzy key extractor.

In another embodiment, the apparatus is in the form of an FPGA (Field Programmable Gate Array).

In another embodiment, the apparatus is in the form of an ASIC (Application-Specific Integrated Circuit).

The respective unit, for example the generation unit, the transmission unit or the frequency spreading unit, can be implemented using hardware and/or else software. In the case of a hardware implementation, the respective unit may be in the form of an apparatus or part of an apparatus, for example in the form of a computer or microprocessor. In the case of a software implementation, the respective unit may be in the form of a computer program product, a function, a routine, part of a program code or an executable object.

A method for transmitting data from an apparatus to a receiver is also proposed. In a first step, an identifier of the apparatus is generated on the basis of a physical fingerprint of the apparatus. In a second step, the data, with an item of sender-specific information produced on the basis of the generated identifier, are transmitted from the apparatus to the receiver.

A computer program product which causes the method explained above to be carried out on a program-controlled device is also proposed.

A computer program product such as a computer program means can be provided or delivered, for example, in the form of a storage medium such as a memory card, a USB stick, a CD-ROM, a DVD or else in the form of a downloadable file from a server in a network. This can be effected, for example in a wireless communication network, by transmitting a corresponding file containing the computer program product or the computer program means.

A data storage medium having a stored computer program with instructions which cause the method explained above to be carried out on a program-controlled device is also proposed.

The above-described properties, features and advantages of this invention and the manner in which they are achieved become clearer and more clearly comprehensible in connection with the following description of the exemplary embodiments which are explained in more detail in connection with the drawings, in which:

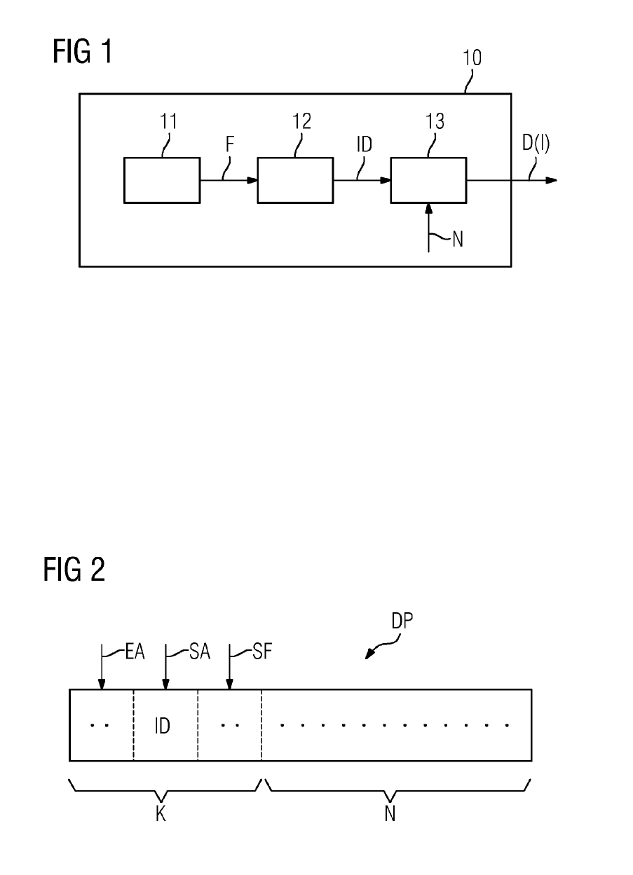

FIG. 1 shows a block diagram of an exemplary embodiment of an apparatus for transmitting data to a receiver;

FIG. 2 shows an example of a data packet;

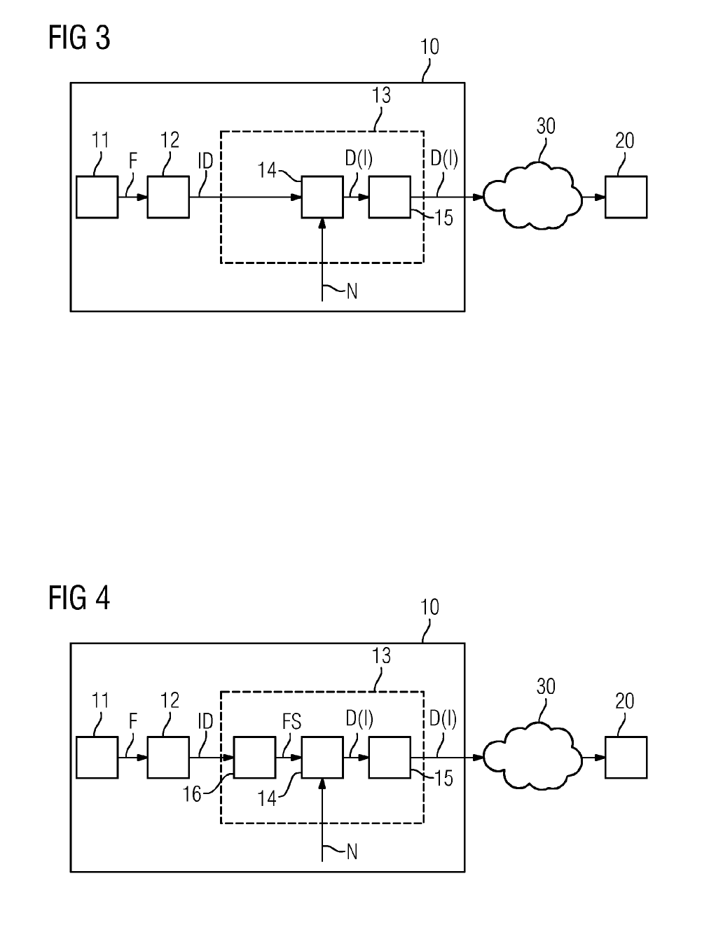

FIG. 3 shows a block diagram of a second exemplary embodiment of an apparatus for transmitting data to a receiver;

FIG. 4 shows a block diagram of a third exemplary embodiment of an apparatus for transmitting data to a receiver;

FIG. 5 shows a block diagram of a fourth exemplary embodiment of an apparatus for transmitting data to a receiver;

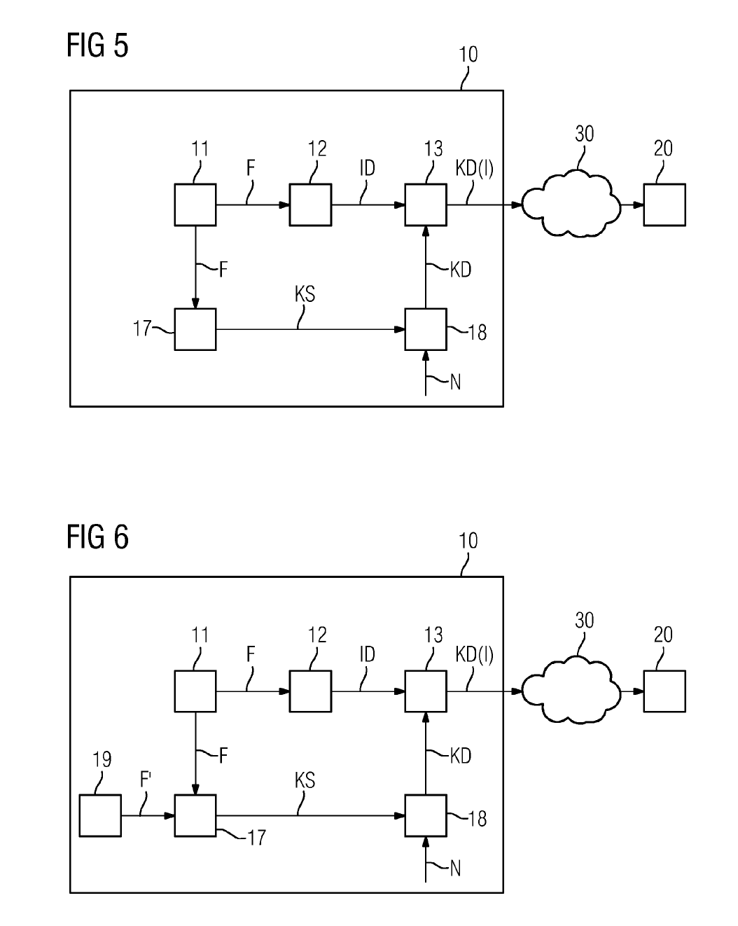

FIG. 6 shows a block diagram of a fifth exemplary embodiment of an apparatus for transmitting data to a receiver; and

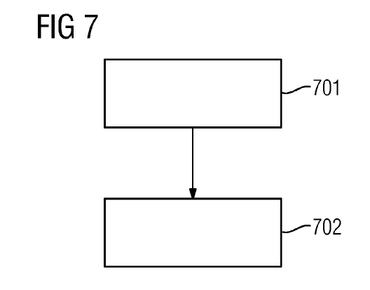

FIG. 7 shows a flowchart of an exemplary embodiment of a method for transmitting data from an apparatus to a receiver.

In the figures, identical or functionally identical elements have been provided with the same reference symbols unless indicated otherwise.

FIG. 1 shows a block diagram of an exemplary embodiment of an apparatus 10 for transmitting data D(I) to a receiver 20.

The apparatus 10 can also be referred to as a sender or transmitting/receiving unit and has an FPGA or an ASIC, for example.

The apparatus 10 comprises a physical structure 11 for providing a physical fingerprint F, a generation unit 12 for generating an identifier ID of the apparatus 10 on the basis of the physical fingerprint F provided, and a transmission unit 13 for transmitting data D(I), with an item of sender-specific information I produced on the basis of the generated identifier ID, to a receiver 20 (not illustrated in FIG. 1).

The data D(I) are formed by the transmission unit 13 using the received identifier ID and received useful data N. The source of the useful data N may be arranged inside or outside the apparatus 10. The identifier ID may also be referred to as an identification of the apparatus 10 or as an apparatus identifier.

For example, the transmission unit 13 is set up to produce an identifier signal as the sender-specific information I using the generated identifier ID and to modulate the produced identifier signal onto a useful data signal for transmitting the data D(I) to the receiver 20. The produced identifier signal is a noise signal, for example.

Furthermore, the transmission unit 13 may also be set up to transmit the sender-specific information I to the receiver 20 by modulating a predetermined side channel during transmission of the data D(I), which modulation is determined on the basis of the generated identifier ID.

Alternatively or additionally, the transmission unit 13 may also be set up to transmit the data D(I) to the receiver 20 in the form of data packets DP containing useful data N and header data K and to form a transmission address SA for the header data K as the sender-specific information I using the generated identifier ID. In this respect, FIG. 2 shows an example of such a usable data packet DP containing header data K and useful data N. As an exemplary refinement of the header data K, the latter have a reception address EA, a transmission address SA and particular status flags SF. The transmission address SA is formed by the generated identifier ID, for example.

FIG. 3 illustrates a second exemplary embodiment of an apparatus 10 for transmitting data D(I) to a receiver 20. The second exemplary embodiment in FIG. 3 is based on the first exemplary embodiment in FIG. 1 and differs in terms of the configuration of the transmission unit 13.

The transmission unit 13 in FIG. 3 has a modulator 14 for modulating the data D(I) and a transmitter 15 for transmitting the modulated data D(I) to the receiver 20 via a predetermined transmission medium 30. In this case, the modulator 14 is preferably set up to initialize the modulation of the data D(I) using the generated identifier ID and to modulate the data D(I) using the initialized modulation in order to transmit the sender-specific information I to the receiver 20.

FIG. 4 shows a block diagram of a third exemplary embodiment of an apparatus 10 for transmitting data D(I) to a receiver 20. The third exemplary embodiment in FIG. 4 is also based on the first exemplary embodiment in FIG. 1 and differs in terms of the configuration of the transmission unit 13. The transmission unit 13 in FIG. 4 comprises a frequency spreading unit 16, a modulator 14 and a transmitter 15.

The frequency spreading unit 16 is set up to initialize a frequency spreading sequence FS using the generated identifier ID. The initialized frequency spreading sequence FS therefore carries the sender-specific information I. The modulator 14 is then set up to modulate the data D(I) using the initialized frequency spreading sequence FS in order to transmit the sender-specific information I and the useful data. The transmitter 15 then transmits the modulated data D(I) to the receiver via a predetermined transmission medium 30. The predetermined transmission medium is, for example, a network which is wired or wireless.

FIG. 5 illustrates a block diagram of a fourth exemplary embodiment of an apparatus 10 for transmitting data D(I) to a receiver 20, which is based on the first exemplary embodiment in FIG. 1. The apparatus 10 in FIG. 5 also comprises a key generation unit 17 for generating a cryptographic key KS. The key generation unit 17 can be initialized by the physical fingerprint F of the apparatus 10 and/or by a further physical fingerprint F′ (not shown) of the apparatus 10. The key generation unit 17 is in the form of a fuzzy key extractor, for example.

The apparatus 10 in FIG. 5 also comprises a production unit 18 for producing cryptographic data KD using the generated cryptographic key KS. The cryptographic data KD comprise, for example, a cryptographic checksum calculated using the produced cryptographic key KS and/or useful data N encrypted using the produced cryptographic key KS.

The transmission unit 13 in FIG. 5 is then set up to transmit the produced cryptographic data KD(I), with an item of sender-specific information I produced on the basis of the generated identifier ID, to the receiver 20 via a predetermined transmission medium 30.

FIG. 6 shows a block diagram of a fifth exemplary embodiment of the apparatus 10 for transmitting data to the receiver 20. The fifth exemplary embodiment in FIG. 6 is based on the fourth exemplary embodiment in FIG. 5 and explicitly shows a further physical structure 19 for providing the further physical fingerprint F′ which is also used to initialize the key generation unit 17.

FIG. 7 illustrates a flowchart of an exemplary embodiment of a method for transmitting data from an apparatus 10 to a receiver 20. The method in FIG. 7 is carried out, in particular, by an apparatus 10 according to one of FIGS. 1 to 6.

The exemplary embodiment in FIG. 7 comprises the following steps 701 and 702:

In step 701, an identifier of the apparatus is generated on the basis of a physical fingerprint of the apparatus.

In step 702, the data, with an item of sender-specific information produced on the basis of the generated identifier, are transmitted to the receiver.

Although the invention has been specifically illustrated and described in detail by means of the preferred exemplary embodiment, the invention is not restricted by the disclosed examples and other variations can be derived therefrom by a person skilled in the art without departing from the scope of protection of the invention.

The invention can also be used to check whether a received data packet is intended for the receiving node, that is to say is addressed to it, using the sender-specific information, for example a PUF. A PUF-based identifier can be used as the destination address here. For this purpose, the receiver determines a query value (challenge value) on the basis of the data in a received data packet. This value is made available to the PUF of the receiving device. The response value provided by the PUF is compared with a response value contained in the data packet. If there is sufficient similarity, the data packet is accepted by the receiving node.

1. An apparatus (10) for transmitting data, having:
a physical structure (11) for providing a physical fingerprint (F),
a generation unit (12) for generating an identifier (ID) of the apparatus (10) on the basis of the physical fingerprint (F) provided, and
a transmission unit (13) for transmitting data (D(I)), with an item of sender-specific information (I) produced on the basis of the generated identifier (ID), to a receiver (20).

2. The apparatus as claimed in claim 1,
characterized in that
the transmission unit (13) is set up to transmit the data (D(I)) to the receiver (20) in the form of data packets (DP) containing useful data (N) and header data (K) and to form a transmission address (SA) for the header data (K) as the sender-specific information (I) using the generated identifier (ID).

3. The apparatus as claimed in claim 2,
characterized in that
the transmission unit (13) is set up to use the generated identifier (ID) as the transmission address (SA).

4. The apparatus as claimed in claim 1,
characterized in that
the transmission unit (13) is set up to produce an identifier signal as the sender-specific information (I) using the generated identifier (ID) and to modulate the produced identifier signal onto a useful data signal for transmitting the data (D(I)) to the receiver (20).

5. The apparatus as claimed in claim 4,
characterized in that
the produced identifier signal is a noise signal.

6. The apparatus as claimed in claim 1,
characterized in that
the transmission unit (13) is set up to transmit the sender-specific information (I) to the receiver (20) by modulating a predetermined side channel during transmission of the data (D(I)), which modulation is determined on the basis of the generated identifier (ID).

7. The apparatus as claimed in claim 1,
characterized in that
the transmission unit (13) has a modulator (14) for modulating the data (D(I)) and a transmitter (15) for transmitting the modulated data (D(I)) to the receiver (20) via a predetermined transmission medium (30).

8. The apparatus as claimed in claim 7,
characterized in that
the modulator (14) is set up to initialize the modulation of the data (D(I)) using the generated identifier (ID) and to modulate the data (D(I)) using the initialized modulation in order to transmit the sender-specific information (I).

9. The apparatus as claimed in claim 1,
characterized in that
the transmission unit (13) comprises a frequency spreading unit (16), a modulator (14) and a transmitter (15), the frequency spreading unit (16) being set up to initialize a frequency spreading sequence (FS) using the generated identifier (ID), the modulator (14) being set up to modulate the data (D(I)) using the initialized frequency spreading sequence (FS) in order to transmit the sender-specific information (I), and the transmitter (15) being set up to transmit the modulated data (D(I)) to the receiver (20) via a predetermined transmission medium (30).

10. The apparatus as claimed in claim 1,
characterized by
a key generation unit (17) which is initialized by the physical fingerprint (F) and/or by a further physical fingerprint (F′) of the apparatus (10) and is intended to generate a cryptographic key (KS), and
a production unit (18) for producing cryptographic data (KD) using the generated cryptographic key (KS),
the transmission unit (13) being set up to transmit the produced cryptographic data (KD(I)), with an item of sender-specific information (I) produced on the basis of the generated identifier (ID), to the receiver (20) via a predetermined transmission medium (30).

11. The apparatus as claimed in claim 10,
characterized by
a further physical structure (19) for providing the further physical fingerprint (F′).

12. The apparatus as claimed in claim 10 or 11,
characterized in that
the cryptographic data (KD) comprise a cryptographic checksum calculated using the produced cryptographic key (KS) and/or useful data (N) encrypted using the produced cryptographic key (KS).

13. The apparatus as claimed in one of claims 10 to 12,
characterized in that
the key generation unit (17) comprises a fuzzy key extractor.

14. The apparatus as claimed in one of claims 1 to 13,
characterized in that
the apparatus (10) comprises a field programmable gate array, FPGA, or an application-specific integrated circuit, ASIC.

15. A method for transmitting data (D(I)) from an apparatus (10) to a receiver (20), having the steps of:
generating (701) an identifier (ID) of the apparatus (10) on the basis of a physical fingerprint (F) of the apparatus (10), and
transmitting the data (D(I)), with an item of sender-specific information (I) produced on the basis of the generated identifier (ID), to the receiver (20).
